(19) United States
(12) Patent Application Publication
(10) Pub. No.: US 2022/0036467 A1
(43) Pub. Date: Feb. 3, 2022

(54) MACHINE LEARNING SYSTEM AND METHOD FOR QUOTE GENERATION

(71) Applicant: The Auto Club Group, Dearborn, MI (US)

(72) Inventors: Shohreh ABEDI, Bloomfield Hills, MI (US); Viral PATEL, Canton, MI (US); Sanjay KUCHIPUDI, Westland, MI (US)

(21) Appl. No.: 16/940,988

(22) Filed: Jul. 28, 2020

(51) Int. Cl. G06Q 40/08; G06F 40/295; G06N 20/00; G06K 9/62

(52) U.S. Cl. CPC G06Q 40/08; G06K 9/6267; G06N 20/00; G06F 40/295

(57) ABSTRACT

An automated quoting system and method is disclosed that may employ a machine-learning model to interpret and extract information from a digital image. The machine learning model may be operable to verify the customer information received and employ prefill data services to compare and merge information together with the information extracted from the digital image. The automated system may use the extracted and acquired customer data to generate and provide one or more quotes to a customer.

### TECHNICAL FIELD

The present disclosure relates to a machine learning model for preparing and generating a quote.

### BACKGROUND

The process of obtaining quotes from clients (e.g., insurance quotes) may be processed by brokers who act on behalf of a customer. In obtaining quotes, application forms must be manually completed requiring the inputting of generic or repetitive information. The completed forms are then typically submitted to a processing company (e.g., insurance companies) who verifies the form and will return quotes to the broker. Not only is this process laborious, it also is prone to errors either by information provided by the customer, information entered by the broker, or information being processed once the form is submitted by the broker to a processing company.

### SUMMARY

A system and method are disclosed for generating a quote (e.g., an insurance quote) from a digital image that may be received from a customer. The system and method may validate that one or more textual data fields received from a digital image satisfy one or more predefined data fields. The system and method may also provide an error notification when the one or more textual data fields do not satisfy the one or more predefined data fields. It is contemplated that the one or more predefined data fields may include a policy discount, a policy coverage, a policy number, or a policy term

In response to receiving the digital image, the system and method may determine if the one or more textual data fields includes a predefined set of optical character recognition data. If the one or more textual data fields do not include the predefined set of optical character recognition data, an optical character recognition algorithm may be employed to recognize one or more alphanumeric characters within the digital image.

A machine learning algorithm may be employed to classify the one or more textual data fields responsive to the one or more textual data fields satisfying the one or more predefined data fields. The machine learning algorithm may include one or more convolutional layers, one or more pooling layers, or a fully connected layer.

The machine learning algorithm may also employ a natural language processing algorithm to read and decipher the one or more textual data fields. The natural language processing algorithm may be operable to manage and apply an overall linguistic meaning to textual excerpts for the one or more textual data fields. Also, the natural language processing algorithm may be operable to employ a syntax analysis algorithm, a sentiment analysis algorithm, an entity analysis algorithm, an entity sentiment analysis algorithm, and a textual classification algorithm.

It is contemplated that the machine learning algorithm may include a pre-processing algorithm to smooth the one or more textual data fields or a feature extraction algorithm to extract the one or more textual data fields from the digital image. The machine learning algorithm may also employ a classification algorithm to validate the one or more textual data fields extracted from the digital image.

It is also contemplated that the machine learning algorithm may be pre-trained using information from the natural language processing algorithm to extract from the one or more textual data fields: a predefined customer data field; a predefined geographical data field; or a predefined insurance risk identifier.

A data pre-fill algorithm may then determine if the one or more textual data fields do not include one or more required data fields necessary to generate the quote from the digital image. The data pre-fill algorithm may operate in response to the machine learning algorithm classifying the one or more textual data fields. The data pre-fill algorithm may also be operable to communicate with an external database to acquire the one or more required data fields that are not identified within the one or more textual data fields. It is contemplated the external database may include a publicly accessible governmental database (e.g., Secretary of State, Department of Motor Vehicles, etc.).

The machine learning algorithm may then operate to compare and merge the one or more textual data fields acquired by the data pre-fill algorithm with the one or more textual data fields provided by the digital image when it is determined a data overlap exists. The quote may then be generated based on the one or more textual data fields. It is contemplated that an application programming interface (API) may be employed to generate the quote to a customer in real-time. Also, prior to generating the quote, the quote may be verified to correct any identified errors.

### BRIEF DESCRIPTION OF THE DRAWINGS

FIG. 1 is an exemplary system for employing an automated quoting system.

FIG. 2 is an exemplary flow diagram that may be employed by the automated quoting system.

FIG. 3 is an exemplary digital image that may be received by the automated quoting system.

FIG. 4 is an exemplary machine learning model that may be employed by the automated quoting system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Traditionally, product offerings for various types of insurance products (e.g., automotive insurance) entail a lengthy and cumbersome process. The amount of time and money spent on the insurance products has traditionally been troublesome because the overall market has remained relatively flat. As a result, insurance providers have been required to spend a greater amount of money on marketing and advertising the insurance products offered.

With respect to product offerings, the conventional process may begin when a customer engages in a conversation with an insurance agent or broker. The conversation may occur over the phone or the customer may visit a branch office to speak directly with the insurance agent. During the conversation, the agent typically requests certain information that is then input to the insurance company server (i.e., policy administration system). Or, the customer may use a computer or mobile device (e.g., smart phone or tablet) to visit an insurance company's website or mobile app to input information that may be required to generate the quote. For instance, the customer may be provide or input the following information: (a) insured/driver details (e.g., name, date of birth, gender, marital status, employment status); address details (e.g., apartment/building information (if any), street number, street name, city, state, zip code); vehicle details (e.g., automotive manufacturer, vehicle model, vehicle year); coverage details (e.g., insurance limits, deductibles, uninsured motorist(s), underinsured motorist); and miscellaneous data (e.g., prior carrier, prior claims, prior accidents).

Once the customer information is acquired, the insurance company server may be operable to perform one or more of the following: address standardization; credit score check; and assessment of vehicle history. However, it is contemplated that the insurance server may be operable to perform further functions necessary to authenticate various customer information necessary for providing the insurance quote. Also, the insurance server may be operably programmed to include proprietary rating algorithms that are used to generate a quote premium for the customer.

More recently, insurance providers have begun to provide the capability for customers to upload their insurance declaration to the insurance server. The insurance declaration may be used by an insurance employee to manually input certain information into the insurance server to generate the quote for the customer. It is therefore contemplated that an automated process would be advantageous that interprets and extracts information from the customer declaration. The automated process may be operable to verify the customer information received and prefill data not included within the customer declaration. The automated system may also be operable to use the extracted and acquired customer data to generate and provide one or more quotes to the customer.

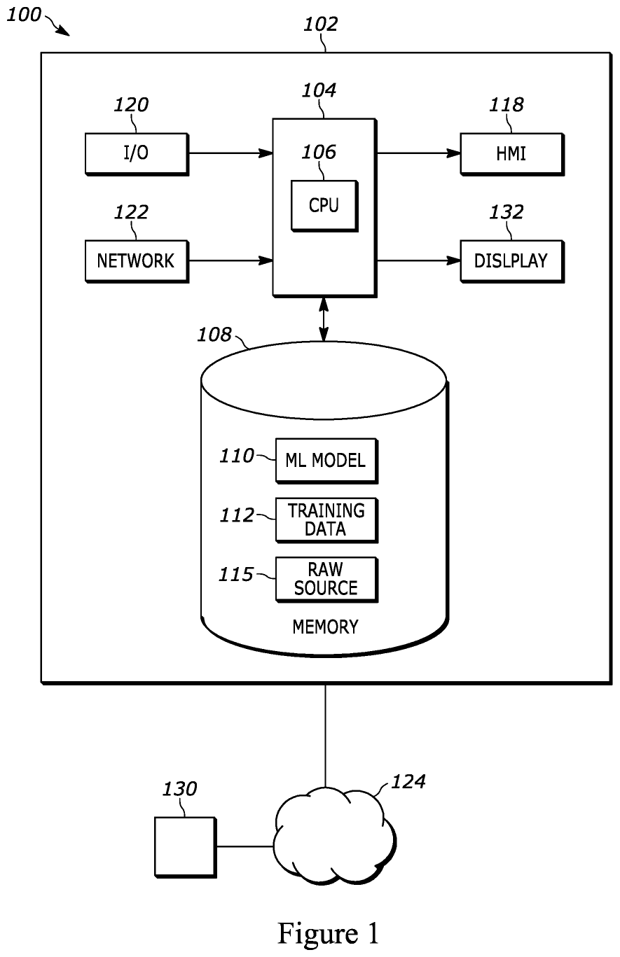

FIG. 1 illustrates an exemplary system 100 that may be used to generate a quote from an insurance declaration. The system 100 may include at least one computing devices 102. The computing device 102 may include at least one processor 104 that is operatively connected to a memory unit 108. The processor 104 may be one or more integrated circuits that implement the functionality of a central processing unit (CPU) 106. The CPU 106 may be a commercially available processing unit that implements an instruction stet such as one of the x86, ARM, Power, or MIPS instruction set families.

During operation, the CPU 106 may execute stored program instructions that are retrieved from the memory unit 108. The stored program instructions may include software that controls operation of the CPU 106 to perform the operation described herein. In some examples, the processor 104 may be a system on a chip (SoC) that integrates functionality of the CPU 106, the memory unit 108, a network interface, and input/output interfaces into a single integrated device. The computing device 102 may implement an operating system for managing various aspects of the operation.

The memory unit 108 may include volatile memory and non-volatile memory for storing instructions and data. The non-volatile memory may include solid-state memories, such as NAND flash memory, magnetic and optical storage media, or any other suitable data storage device that retains data when the computing system 102 is deactivated or loses electrical power. The volatile memory may include static and dynamic random-access memory (RAM) that stores program instructions and data. For example, the memory unit 108 may store a machine-learning model 110 or algorithm, training dataset 112 for the machine-learning model 110, and/or raw source data 115. However, it is contemplated that the memory unit 108 may store additional forms of data or programs.

The computing device 102 may include a network interface device 122 that is configured to provide communication with external systems and devices. For example, the network interface device 122 may include a wired and/or wireless Ethernet interface as defined by Institute of Electrical and Electronics Engineers (IEEE) 802.11 family of standards. The network interface device 122 may include a cellular communication interface for communicating with a cellular network (e.g., 3G, 4G, 5G). The network interface device 122 may be further configured to provide a communication interface to an external network 124 or cloud.

The external network 124 may be referred to as the world-wide web or the Internet. The external network 124 may establish a standard communication protocol between computing devices. The network could also include private networks or company specific network. The external network 124 may allow information and data to be easily exchanged between computing devices and networks. One or more servers 130 may be in communication with the external network 124.

The computing device 102 may include an input/output (I/O) interface 120 that may be configured to provide digital and/or analog inputs and outputs. The I/O interface 120 may include additional serial interfaces for communicating with external devices (e.g., Universal Serial Bus (USB) interface).

The computing device 102 may include a human-machine interface (HMI) device 118 that may include any device that enables the system 100 to receive control input. Examples of input devices may include human interface inputs such as keyboards, mice, touchscreens, voice input devices, and other similar devices. The computing system 102 may include a display device 132. The computing system 102 may include hardware and software for outputting graphics and text information to the display device 132. The display device 132 may include an electronic display screen, projector, printer or other suitable device for displaying information to a user or operator. The computing system 102 may be further configured to allow interaction with remote HMI and remote display devices via the network interface device 122.

The system 100 may also be implemented using one or multiple computing systems. While the example depicts a single computing device 102 that implements all the described features, it is intended that various features and functions may be separated and implemented by multiple computing units in communication with one another. The system architecture selected may depend on a variety of factors.

The system 100 may implement a machine-learning algorithm 110 that is configured to analyze the raw source data 115 (or dataset). The raw source data 115 may include a digital image or partially processed sensor data (e.g., data from digital camera or digital scanner). In some examples, the machine-learning algorithm 110 may be a neural network algorithm (e.g., CNN or DNN) that may be designed to perform a predetermined function.

The system 100 may further be connected to receive data from a customer device (e.g., tablet, phone, laptop). The system 100 may then store the data within the memory 108. Alternatively, system 100 may be the customer device that is operable to store and run a program or application (i.e., app) available from an insurance provider. The program/app may be in communication with insurance provider to generate the quote for the customer.

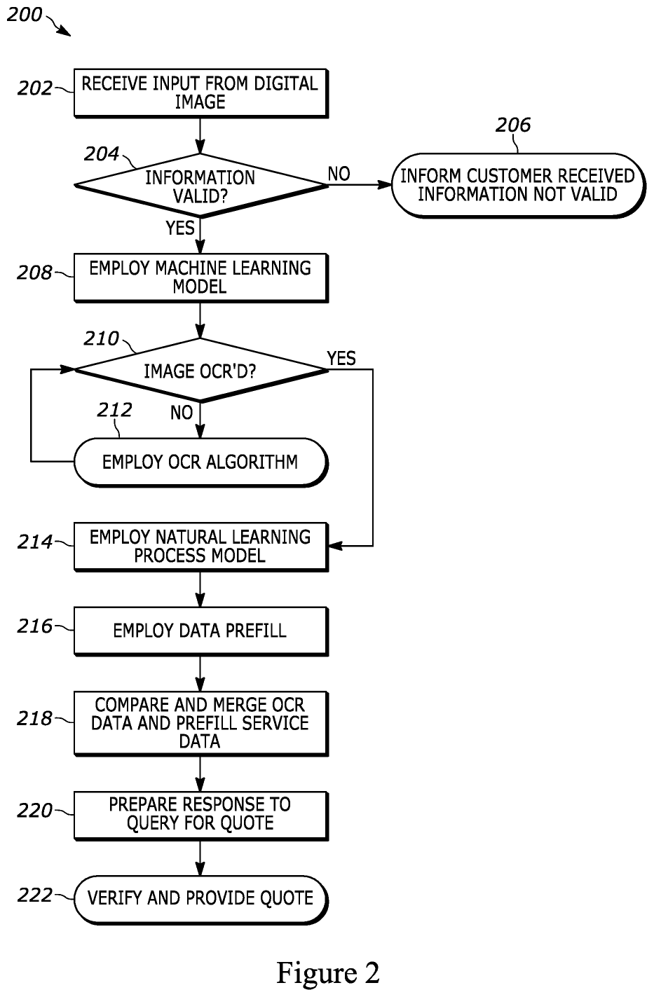

FIG. 2 illustrates a flow diagram 200 that may be implemented by system 100 for generating a quote from a customer declaration. At step 202, the system 100 may receive a digital image (i.e., input) of an insurance declaration. It is contemplated that the digital image may be provided using conventional image file formats (e.g., tiff, jpeg, gif, or png) or as a post-script document format (e.g., PDF).

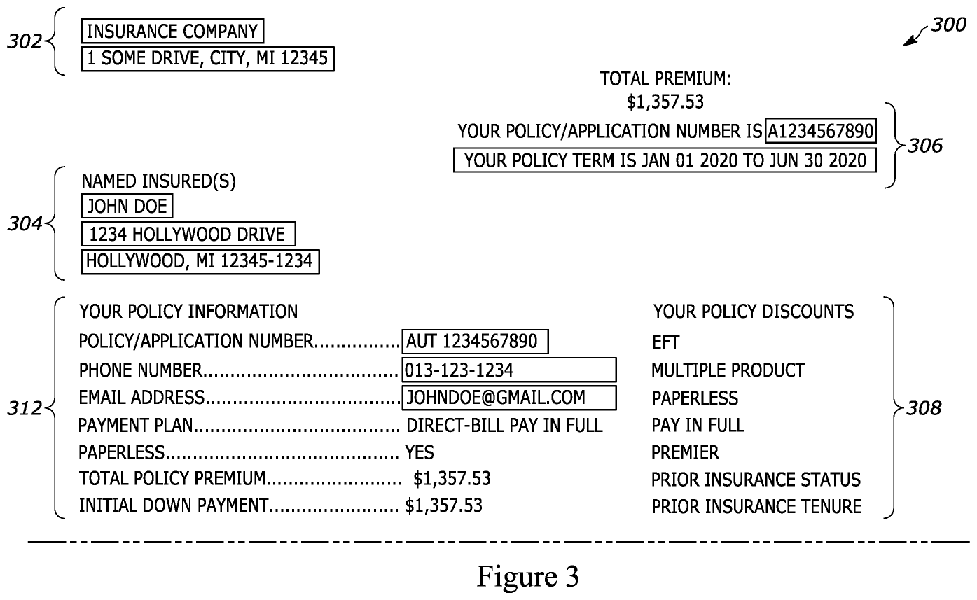

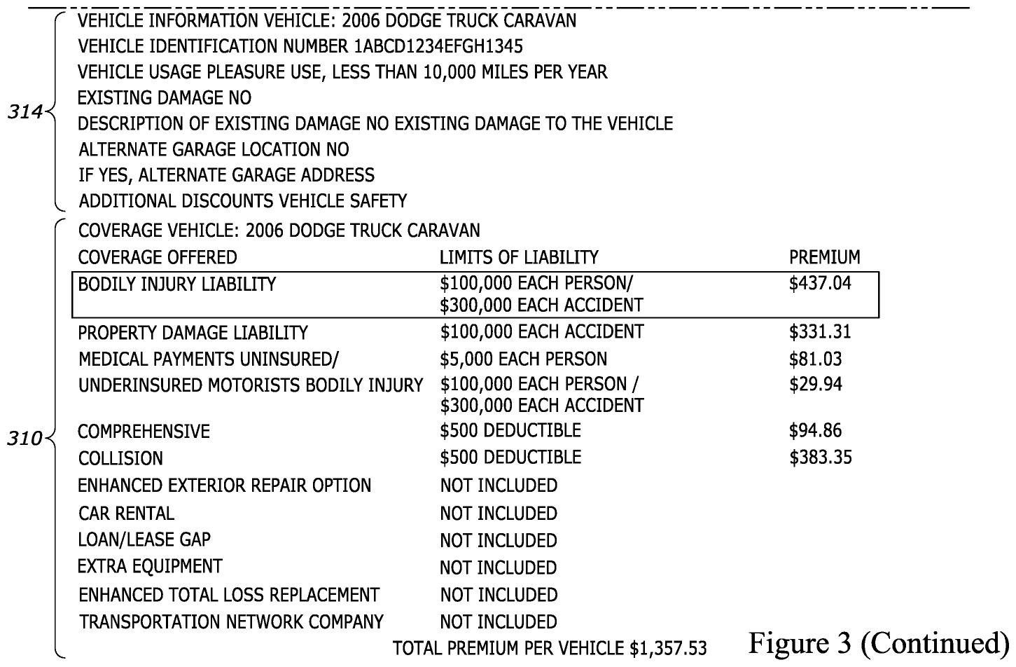

FIG. 3 illustrates an exemplary insurance declaration 300 that may be the digital image received by the system 100. The insurance declaration 300 may include textual information that includes the current insurance provider's name and address 302. The insurance declaration 300 may also include customer information 304 like the insured customer's name and address. The insurance declaration 300 may also include vehicular information 314 like a vehicle identification number, description of the vehicle, and vehicle usage data. The insurance declaration 300 may also provide the additional textual information about the customer's current insurance policy: (a) policy number and term 306; policy discounts 308; policy coverage 310; and additional policy information 312.

Once the customer information (i.e., customer declaration 300) is received, the flow diagram 200 may then proceed to Step 204 where the system 100 may determine if the information received is valid. If Step 204 determines the information is not valid, flow diagram proceeds to Step 206 where the system 100 provides a notification to the customer that the insurance declaration cannot be used to generate an insurance quote. If Step 204 determines the information is valid, flow diagram 200 proceeds to Step 208 where the machine learning model 100 is employed to understand the content of the digital image (e.g., insurance declaration 300).

The machine learning model 100 may be operable to identify, recognize and extract information required for generating the insurance quote. It is contemplated that the machine learning model 110 may also be operable to extract from the insurance declaration 300 one or more portions of unstructured textual data (e.g., customer information 304 and vehicular information 314). The unstructured textual data may then be converted to structured textual data that is used by system 100 to understand prior customer insurance policies and coverages.

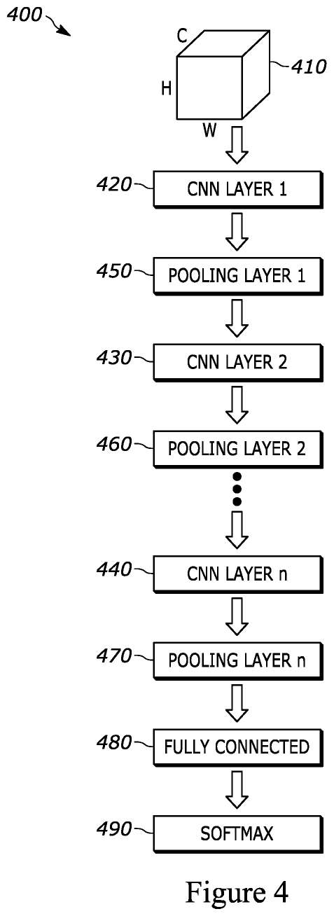

Again, the machine learning model 110 may be a deep-learning neural network algorithm such as CNN, DNN, or RNN. For instance, FIG. 4 illustrates a non-limiting example of a CNN 400 that includes: an input dataset 410; one or more convolutional layers 430-440; one or more pooling layers 450-470; a fully connected layer 480; and a softmax layer 490.

While it is contemplated that the input dataset 410 may be the insurance declaration 300, it is also contemplated that the input dataset 410 may include other forms of textual data that is provided to the system 100. It is also contemplated that input dataset 410 may be lightly processed prior to being provided to CNN 400. Convolutional layers 420-440 may be operable to extract features from the input dataset 410. It is generally understood that convolutional layers 420-440 may be operable to apply filtering operations (e.g., kernels) before passing on the result to another layer of the CNN 400. For instance, for a given dataset, the convolution layers may execute filtering routines to perform operations such as image identification, edge detection of an image, and image sharpening.

It is also contemplated that the CNN 400 may include one or more pooling layers 450-470 that receive the convoluted data from the respective convolution layers 420-440. Pooling layers 450-470 may include one or more pooling layer units that apply a pooling function to one or more convolution layer outputs computed a different bands using a pooling function. For instance, pooling layer 450 may apply a pooling function to the kernel output received from convolutional layer 420. The pooling function implemented by pooling layers 450-470 may be an average or a maximum function or any other function that aggregates multiple values into a single value.

A fully connected layer 480 may also be operable to learn non-linear combinations for the high-level features in the output data received from the convolutional layers 420-440 and pooling layers 450-470. Lastly, CNN 400 may include a softmax layer 490 that combines the outputs of the fully connected layer 480 using softmax functions.

At Step 210 the machine learning model 110, or separate program, to determine if the digital image includes optical character recognition (OCR) data. If the digital image does not include OCR data, the flow diagram proceeds to step 212 where an OCR algorithm is employed. The OCR algorithm may be employed to recognize textual, character and image information from the insurance declaration 300. The OCR algorithm may begin by decoding the attachment using a base 64 image format. An OCR API may be initiated, and the decoded document may then be transmitted as an attachment. An OCR response timeout (e.g., 200 ms) may determine if the filename has been transmitted. If the file has been successfully transmitted, the OCR algorithm may then operate to split each line of information included within the document. Once the OCR algorithm has successfully converted each line of text, flow diagram 200 may return to Step 210.

If Step 210 determines the digital image includes OCR data, the machine learning model 110 may complete: (a) a pre-processing algorithm that smooths the textual data; (b) a feature extraction algorithm that correctly extracts necessary information from the insurance declaration 300; and (c) a classification algorithm that ensures correct classification of the information extracted from the insurance declaration 300. Flow diagram 200 may then proceed to step 214 where a natural language processing (NLP) algorithm is employed.

It is also contemplated that the machine learning model 110 may be pre-trained using information from the NLP algorithm to be operable to extract information about a customer(s), geographical locations, or other key identifiers of insurance risk. If NLP algorithm is used to simply train machine learning model 110, flow diagram 200 may not be required to include Step 214. It is contemplated, however, that the NLP algorithm may also enable the system 100 to derive certain categorical (i.e., structured data) from the unstructured insurance declaration 300 received from customer at Step 202. By employing the NLP algorithm to gain information about the customer (e.g., name, location, organization, vehicle types, address), the system 100 may be capable of providing a more accurate quote to the customer. It is contemplated that the NLP algorithm assists machine learning model 110 to accurately managing and applying an overall linguistic meaning to text excerpts (e.g., phrases or sentences) within the insurance declaration 300. The NLP algorithm may employ syntax analysis, sentiment analysis, entity analysis, entity sentiment analysis, and textual classification.

Flow diagram 200 may then proceed to Step 216 where a data pre-fill algorithm may be employed by system 100. It is contemplated that system 100 may not have acquired all the relevant information in Steps 208 and 214 to provide an accurate quote to the customer. Step 216 may therefore be used to augment Steps 208 and 214 by leveraging real-time 3^{rd} party data provider services.

For instance, customers don't always know or have readily available the information pertaining to insurance coverage limits on current or existing policies. System 100 may have previously stored within memory 108 the information required based on a past interaction with customer. Or system 100 may connected by external network 124 to a 3^{rd} party service (i.e., server 130) that may have the necessary information. Such 3^{rd} party services may include other insurance providers, a customer data platform, or government entities (e.g., Department of Motor Vehicles). System 100 may further connect to an additional server using network 122 where customer information may be stored. The information stored either internally on memory 108 or externally may include a customer's VIN number, driver license details, information about additional driver's within customer's household.

It is contemplated that in addition to prefilling any missing data, Step 216 may further validate the information acquired by Steps 208 and 214. For instance, information may have been provided by customer's to insurance providers or call centers (e.g., servers 130) that are external to system 100. These external servers 130 (i.e., external prefill services) may be accessed by system 100 by external network 124 to acquire customer data that may not have been acquired by Steps 208 and 214.

Flow diagram 200 may then proceed to Step 218 where the extracted OCR data is compared against the data received from the prefill service. Step 218 may operate to extract the intersection of select customer data from the vendor prefill data. If a match is found, the machine learning algorithm 110 may merge the coverages between the OCR data and the vendor prefill data and proceed to Step 220. If no matches are found, the flow diagram may terminate at step 218.

At Step 220 a real-time-quote algorithm may be employed to generate the insurance quote. The real-time-quote algorithm may specifically employ an insurance company's policy administrator system for generating the insurance quote. It is contemplated that the policy administrator system may include an API (“Application Programming Interface”) friendly insurance platform that can generate a quote in real-time. The policy administrator system may be operable to include underwriting, policy, and product management systems that support underwriters as they serve agents and policyholders. The policy administrator system may also be used to execute several core policy processes including rating, quoting, binding, issuing, endorsements, and renewals. The policy administrator system may be included as part of a larger system that is used to record all policies that an insurance company has written. The process disclosed may include all the accumulated data that system 100 may need to acquire or handle to generate an insurance quote for the customer.

Flow diagram may then proceed to step 222 where the system 100 may prepare and transmit the quote to the customer. At step 222, final verification checks may be performed to determine if any additional corrections need to occur before the quote is transmitted to the customer. If no further corrections need to occur, the quote is transmitted to customer. The quote may be transmitted to contact information (e.g., email address) extracted from the customer declaration 300. Or the quote may be transmitted to a contact information provided by the customer at the start of the process.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for generating a quote from a digital image, comprising:
responsive to receiving a digital image having one or more textual data fields from a remote computer, validating that the one or more textual data fields satisfy one or more predefined data fields;
responsive to the one or more textual data fields satisfying the one or more predefined data fields, employing a machine learning algorithm to classify the one or more textual data fields, wherein the machine learning algorithm includes a natural language processing algorithm operable to read and decipher the one or more textual data fields;
responsive to the machine learning algorithm classifying the one or more textual data fields, employing a data pre-fill algorithm to determine if the one or more textual data fields do not include one or more required data fields necessary to generate the quote from the digital image, wherein the data pre-fill algorithm is operable to communicate with an external database to acquire the one or more required data fields that are not identified within the one or more textual data fields;
employing the machine learning algorithm to compare and merge the one or more textual data fields acquired by the data pre-fill algorithm with the one or more textual data fields provided by the digital image when it is determined a data overlap exists; and
responsive to the machine learning algorithm comparing and merging the one or more textual data fields acquired by the data pre-fill algorithm with the one or more textual data fields provided by the digital image, generating the quote based on the one or more textual data fields.

2. The method of claim 1, further comprising: providing an error notification when the one or more textual data fields do not satisfy the one or more predefined data fields.

3. The method of claim 1, wherein at least one of the one or more predefined data fields comprise a policy discount, a policy coverage, a policy number, or a policy term.

4. The method of claim 1 further comprising: responsive to receiving the digital image from the remote computer, determining if the one or more textual data fields includes a predefined set of optical character recognition data.

5. The method of claim 4, responsive to the one or more textual data fields not including the predefined set of optical character recognition data, employing an optical character recognition algorithm to recognize one or more alphanumeric characters within the digital image.

6. The method of claim 1, wherein the machine learning algorithm includes a pre-processing algorithm to smooth the one or more textual data fields.

7. The method of claim 1, wherein the machine learning algorithm may include a feature extraction algorithm to extract the one or more textual data fields from the digital image.

8. The method of claim 1, wherein a classification algorithm employed by the machine learning algorithm validates the one or more textual data fields extracted from the digital image.

9. The method of claim 1, wherein the machine learning algorithm is pre-trained using information from the natural language processing algorithm to extract from the one or more textual data fields a predefined customer data field.

10. The method of claim 1, wherein the machine learning algorithm is pre-trained using information from the natural language processing algorithm to extract from the one or more textual data fields a predefined geographical data field.

11. The method of claim 1, wherein the machine learning algorithm is pre-trained using information from the natural language processing algorithm to extract a predefined insurance risk identifier from the one or more textual data fields.

12. The method of claim 1, wherein the natural language processing algorithm is operable to manage and apply an overall linguistic meaning to textual excerpts for the one or more textual data fields.

13. The method of claim 1, wherein the natural language processing algorithm is operable to employ a syntax analysis algorithm, a sentiment analysis algorithm, an entity analysis algorithm, an entity sentiment analysis algorithm, and a textual classification algorithm.

14. The method of claim 1, wherein the machine learning algorithm includes one or more convolutional layers, one or more pooling layers, and a fully connected layer.

15. The method of claim 1, wherein the external database includes a publicly accessible governmental database.

16. The method of claim 1, wherein an application programming interface generates the quote to a customer in real-time.

17. The method of claim 1, further comprising verifying the quote and correcting any identified errors prior to generating the quote.

18. A system for generating a quote from a digital image, comprising:
a processor operable to:
validate that one or more textual data fields received from a digital image satisfy one or more predefined data fields;
employ a machine learning algorithm to classify the one or more textual data fields responsive to the one or more textual data fields satisfying the one or more predefined data fields, wherein the machine learning algorithm includes a natural language processing algorithm operable to read and decipher the one or more textual data fields;
employ a data pre-fill algorithm to determine if the one or more textual data fields do not include one or more required data fields necessary to generate the quote from the digital image responsive to the machine learning algorithm classifying the one or more textual data fields, wherein the data pre-fill algorithm is operable to communicate with an external database to acquire the one or more required data fields that are not identified within the one or more textual data fields;
employ the machine learning algorithm to compare and merge the one or more textual data fields acquired by the data pre-fill algorithm with the one or more textual data fields provided by the digital image when it is determined a data overlap exists; and
generate the quote based on the one or more textual data fields responsive to the machine learning algorithm comparing and merging the one or more textual data fields acquired by the data pre-fill algorithm with the one or more textual data fields provided by the digital image.

19. The system of claim 18, wherein the processor is further operable to: determine if the one or more textual data fields includes a predefined set of optical character recognition data responsive to receiving the digital image.

20. A non-transitory computer-readable medium operable to generate a quote, the non-transitory computer-readable medium having computer-readable instructions stored thereon that are operable to execute one or more functions that perform the following:
validate that one or more textual data fields received from a digital image satisfy one or more predefined data fields;
employ a machine learning algorithm to classify the one or more textual data fields responsive to the one or more textual data fields satisfying the one or more predefined data fields, wherein the machine learning algorithm includes a natural language processing algorithm operable to read and decipher the one or more textual data fields;
employ a data pre-fill algorithm to determine if the one or more textual data fields do not include one or more required data fields necessary to generate the quote from the digital image responsive to the machine learning algorithm classifying the one or more textual data fields, wherein the data pre-fill algorithm is operable to communicate with an external database to acquire the one or more required data fields that are not identified within the one or more textual data fields;
employ the machine learning algorithm to compare and merge the one or more textual data fields acquired by the data pre-fill algorithm with the one or more textual data fields provided by the digital image when it is determined a data overlap exists; and
generate the quote based on the one or more textual data fields responsive to the machine learning algorithm comparing and merging the one or more textual data fields acquired by the data pre-fill algorithm with the one or more textual data fields provided by the digital image.
